(19) United States
(12) Patent Application Publication
(10) Pub. No.: US 2008/0005852 A1
(43) Pub. Date: Jan. 10, 2008

(54) Durable multifunctional finishing of fabrics

(75) Inventors: Cheng Hu, Alameda, CA (US); William Ware JR., Redwood City, CA (US)

Correspondence Address: JACQUELINE S LARSON, 245 AVINGTON ROAD, ALAMEDA, CA, 94502, US

(73) Assignee: Nano-Tex, Inc.

(21) Appl. No.: 11/901,008

(22) Filed: Sep. 14, 2007

Related U.S. Application Data
(63) Continuation-in-part of application No. 11/191,442, filed on Jul. 27, 2005.
(60) Provisional application No. 60/844,903, filed on Sep. 15, 2006.
(60) Provisional application No. 60/591,296, filed on Jul. 27, 2004.
(60) Provisional application No. 60/624,875, filed on Nov. 3, 2004.

(51) Int. Cl. C11D 3/00

(52) U.S. Cl. 8/115.51

(57) ABSTRACT

Finishes for imparting antistatic property and a second performance-enhancing property to a fabric, such as a synthetic fabric, are disclosed. The antistatic property and the second performance-enhancing property are compatible with each other. The antistatic and performance-enhancing properties are durable and can withstand many home launderings. In addition, methods for applying polyelectrolytes complexes to fabrics to impart a persistent performance-enhancing property to the fabric are disclosed. Fabrics having durable performance-enhancing finishes are described.

### CROSS REFERENCE TO RELATED APPLICATIONS

This application is a continuation-in-part of U.S. Ser. No. 11/191,442 filed on Jul. 27, 2005, which claims priority to U.S. Ser. No. 60/591,296 filed on Jul. 27, 2004 and to U.S. Ser. No. 60/624,875 filed on Nov. 3, 2004. This application also claims priority to U.S. Ser. No. 60/844,903 filed on Sep. 15, 2006. All of the aforenamed applications are hereby incorporated by reference in their entirety.

### FIELD

The compositions and methods described herein are in the field of performance-enhancing treatments for fabrics, more specifically to durable finishes providing multifunctional performance-enhancing properties, including antistatic behavior, and to methods of applying such finishes to fabrics, including fibers, non-wovens, leathers, films, and plastics. The treated fabrics are particularly useful in non-industrial applications, such as garments, footwear, draperies, curtains, bedding, upholstery, outdoor fabrics (e.g., for umbrellas, awnings, tents, and the like), carpets and rugs. The treated fabrics may also be useful in automobile interiors and technical textiles.

### BACKGROUND

It is often desired to impart performance-enhancing characteristics to fibers and fabrics by applying surface coatings. Examples of such characteristics include antistatic properties, stain resistant properties, soil release properties, repellency or resistance, e.g., for oil or water, moisture wicking properties, antimicrobial properties, and flame retardancy. However, such performance-enhancing coatings are typically not durable. That is, they lose their effectiveness after laundering, cleaning, or exposure to water, oil or contaminants, or by mechanical stress (e.g., by stretching or abrasion).

Synthetic polymeric fibers and fabrics have a tendency to retain static electrical charge for long periods of time. Electrostatic build-up can occur rapidly and dissipation of the charge can be extremely slow (many hours or longer). This property can cause handling problems during manufacturing, wearer discomfort for garments, and electrical shocks from garments and carpets and the like. In addition, electrically charged materials may attract dust, dirt and lint. Therefore, electrically charged synthetic fabrics and fibers can benefit from dissipation of static charge.

Numerous methods have been proposed to dissipate electrostatic charge on fabrics. Examples of such methods include the application of an antistatic agent onto the surfaces of fabrics. Antistatic agents cover a broad range of chemical classes, including organic amines and amides, esters of fatty acids, organic acids, polyoxyethylene derivatives, polyhydridic alcohols, metals, carbon black, semiconductors, and various organic and inorganic salts. Many are also surfactants and can be neutral or ionic. Such agents, however, have proven to lack durability because of their solubility in water. Antistatic properties are typically lost during washing, cleaning or by mechanical damage. It has also been proposed that an antistatic agent be incorporated directly into a polymeric substrate during its formation, while at the same time attempting to maintain the fiber's spinnability and quality of construction.

The accumulation of static charges and the slow dissipation thereof on synthetic fibers can prevent finished, polymeric fabrics from draping or wearing in a desirable manner. Fibers having a high electrostatic susceptibility often cling to guides and rolls in textile machinery during manufacturing and processing and can be damaged and weakened as a result, lowering yield or quality of the end product. For these reasons, and because end-uses for fabrics such as garments, upholstery, hosiery, rugs, bedding, curtains and draperies can benefit by a reduced tendency to accumulate and maintain electrostatic charges, a permanent antistatic composition to be applied thereon is needed.

Presently, in the commercial production of synthetic polymeric fibers, the as-spun filaments are typically given some treatment to improve their electrostatic and handling properties. This treatment usually consists of passing the filaments while in the form of a bundle through a bath or over a wheel coated with a treating of finishing liquid. The finish thus applied is a coating and is not of a permanent nature. Most, if not all, of the antistatic agent on the fiber surface is lost in subsequent processing of the filament by mechanical handling, heating, washing, scouring and dyeing. If the antistatic agent does remain on the fiber until the final end product is produced, it often becomes less effective after the end product is used for a period of time, and especially after a number of washings or dry cleaning operations.

Efforts have been made in the past to produce permanent antistatic polymeric fibers and articles by the application of a more permanent coating. However, due to harsh finishing applications, the coatings would either be removed and/or fail to perform adequately. Attempts have also been made to incorporate antistatic type co-monomers directly into the base polymeric materials. These methods have proven unsuccessful for various reasons, such as a resultant harsh fiber surface or sacrifice of desired fiber physical properties.

Another way to achieve a durable antistatic material is to weave conductive fibers into synthetic textiles. However, the fibers tend to show as streaks through the fabric, which is not desirable. Additionally, fibers can break, thus losing their conductivity, and conductive fibers can have much higher cost than antistatic finishing.

Antistatic compositions are also used for enhancing the receptivity of plastic surfaces to electrostatically applied coatings, e.g., in automobile production. In this application it is also desirable that the antistatic composition resists removal when exposed to an aqueous rinse or wash liquid.

It would be desirable to have a fabric that exhibits not only antistatic behavior but also additional performance-enhancing characteristics, such as water repellency, oil repellency, soil release, hydrophilicity and the like.

Various fluorochemicals have been used to impart water and oil repellency to a wide variety of substrates (see, e.g., U.S. Pat. Nos. 6,855,772; 6,472,476; 6,617,267; and 6,379,753). These fluorochemicals have most often been applied topically, such as dipping, padding, exhaustion, spraying, and coating.

Antistatic property is highly desirable for water and oil repellent finishing. However, the repellent topical finishing usually worsens substrate antistatic property. Additionally, durability to home and commercial laundries are required for both antistatic and repellent functions on apparel. Thus, the first technical difficulty to combine antistatic and repellent finishing together was that there were no truly wash-durable (for example, last 20 to 30 home laundry cycles) antistatic chemicals on the market. Secondly, most antistatic chemicals are incompatible with repellent topical finishing. One function tends to negatively affect the other. Only a few fluorochemical-compatible antistatic chemicals are commercially available and these are not durable. They are mainly organic phosphorous compounds. Their antistatic property is totally lost after one home laundry. Known commercial products include Zerostat® FC New from Ciba, Afilan® FC from Clariant and Repearl® AS-200 from Mitsubishi. U.S. Pat. No. 6,924,329 also describes a non-durable antistatic composition with water and oil repellent fluorochemicals. In JP2006124879, a hydrophilic polyester type antistatic chemical was applied together with fluoropolymer onto polyester fabric to achieve water repellency with semi-durable antistatic property (only to 10 home laundry cycles). Due to its polyester nature of the antistatic agent, it was only applicable on polyester substrates. Other limitations of the method include negative impact on disperse dye colorfastness, a well-know issue in the textile industry.

Fabrics made from untreated polyester, nylon and other synthetic materials do not readily absorb moisture, due to being hydrophobic. As a result, when untreated synthetic fabrics are worn under conditions of even moderate perspiration, moisture tends to build up on the skin, because the fabric does not absorb moisture. Thus, when wearing untreated garments made of synthetic fibers, water tends to bead up and become trapped on the inner surface of the garment, resulting in an extremely uncomfortable garment. A variety of methods having been used to render the surface of fabrics hydrophilic: surface hydrolysis, surface irradiation, and hydrophilic chemical treatment. See, e.g., U.S. Pat. Nos. 6,855,772 and 6,544,594.

Thus, there has been a need for methods and compositions for modifying various fabrics to alter and optimize their properties for use in different applications. In particular, there is a need for methods and compositions for a topical treatment of synthetic fabrics that not only provides antistatic properties but also exhibits additional performance-enhancing properties, such as for example water and oil repellency or soil release capability, and which substrate treatment is further durable to home and commercial laundering. However, previously the lack of a durable antistatic treatment resulted in the lack of a durable additional performance-enhancing treatment, or the prior antistatic treatments were not compatible with other performance-enhancing treatments, or other issues led to the inability to obtain a fabric with two or more different performance-enhancing properties.

Polyelectrolytes are high molecular weight ionic polymers whose solutions are highly electrically conductive. Polyelectrolyte complexes can be formed by combining solutions of oppositely charged polyelectrolytes. The oppositely charged polymers form relatively insoluble complexes due to electrostatic interactions between the polyelectrolytes. In addition, thin polymeric films created by layer-by-layer (LbL) deposition of polyelectrolyte layers have been used to modify the surface properties of materials. During LbL film growth, a charged substrate is dipped back and forth between solutions of positively and negatively charged polyelectrolytes, with a washing step in between each dipping step. During each dipping step, polyelectrolyte is adsorbed onto the surface and the surface charge is thereby reversed, allowing the build-up of polycation-polyanion layers. The polyelectrolyte layers are capable of self-organization, where the driving force behind layer build-up involves electrostatic interactions between the oppositely charged layers. Using electrostatic interactions to form multiple layers can be particularly advantageous because electrostatic interactions do not have the same steric limitations as chemical bonds. Such processes are described for example, in Decher, Science, vol. 277, 29 August 1997, 1232-1237, and U.S. Pat. No. 5,208,111, which are hereby incorporated by reference. Advantages of LbL coatings include their ability to conformably coat objects and their use of water-based processing. Polyelectrolytes can function as filtration barriers, with tunable permeability for gases, liquids, molecules and ions, e.g., as filtration membranes for ion exchange. In addition polyelectroytes have been used for battery electrodes, for anticorrosion coatings for metal objects, for thin optical coatings, and for antistatic coatings for electronic applications.

### SUMMARY

Described herein are multifunctional durable performance-enhancing finishes for fabrics, methods for applying multifunctional durable performance-enhancing finishes to fabrics, and treated fabrics that exhibit multifunctional durable performance-enhancing properties. The present invention is useful in one embodiment for imparting durable antistatic behavior together with a durable second performance-enhancing property to fabrics.

In one aspect, the present invention is directed to a finish for imparting antistatic property and a second performance-enhancing property to a fabric, the finish comprising i) one layer comprising a cationic and anionic polymer polyelelectrolyte complex or a cationic coupling agent, and ii) another layer comprising a composition capable of imparting the second performance-enhancing property to the fabric; and wherein the antistatic property and the second performance-enhancing property are durable. In some variations, the polymer polyelectrolyte complex is formed by first attaching one of the anionic polymer and the cationic polymer to at least a portion of a surface of the fabric and subsequently applying the other of the anionic polymer and the cationic polymer to the fabric. In some variations, the polyelectrolyte complex is formed by first combining the cationic polymer and the anionic polymer in solution. In one embodiment, the fabric is a synthetic fabric, such as for example polyester or nylon. In one embodiment, the fabric is a natural fabric, such as for example cotton, wool or silk.

In another aspect, a method of treating a fabric to impart durable antistatic property and a durable second performance-enhancing property is provided, wherein the method comprises modifying a surface of the fabric by a) providing ions or ionizable compounds having a first charge on at least a portion of the surface; b) applying a first ionic polymer to the fabric, wherein the first ionic polymer has a charge opposite the first charge and at least a portion of the first ionic polymer interacts with the ions or ionizable compounds of the modified surface; c) applying a composition to the fabric, wherein the composition is capable of imparting the second performance-enhancing property to the fabric; and d) drying and curing the fabric. In some variations, the modification of the surface of the fabric comprises applying a second ionic polymer having the first charge to the fabric. In other variations, the first ionic polymer has a charge density greater than 1 meq/g. In still other variations, both the first ionic polymer and the second ionic polymer have charge densities greater than 1 meq/g. In one embodiment, the fabric is a synthetic fabric, such as for example polyester or nylon. In one embodiment, the fabric is a natural fabric, such as for example cotton, wool or silk.

In another aspect, a method for treating a fabric to impart durable antistatic property and a durable second performance-enhancing property is provided, the method comprising a) applying a polyelectrolyte complex between a cationic polymer and an anionic polymer to a surface of the fabric; b) applying a composition to the fabric, wherein the composition is capable of imparting the second performance-enhancing property to the fabric; and c) drying and curing the fabric. In other variations, the first ionic polymer has a charge density greater than 1 meq/g. In still other variations, both the first ionic polymer and the second ionic polymer have charge densities greater than 1 meq/g. In one embodiment, the fabric is a synthetic fabric, such as for example polyester or nylon. In one embodiment, the fabric is a natural fabric, such as for example cotton, wool or silk.

In another aspect, the invention is directed to a fabric that exhibits durable antistatic property and a durable second performance-enhancing property. A finish is disposed on the fabric, the finish comprising i) one layer disposed on at least a portion of the fabric, the layer comprising a cationic and anionic polymer complex or a cationic coupling agent, and ii) another layer disposed on at least a portion of the fabric, the layer comprising a composition capable of imparting the second performance-enhancing property to the fabric; and wherein the antistatic property and the second performance-enhancing property are durable. In some variations, each of the antistatic and the second performance-enhancing property persists after 25 home launderings of the fabric. In other variations, each of the antistatic and the second performance-enhancing property persists after 50 home launderings of the fabric. In one embodiment, the fabric is a synthetic fabric, such as for example polyester or nylon. In one embodiment, the fabric is a natural fabric, such as for example cotton, wool or silk.

It is contemplated that any combination of methods and compositions may be used to produce the fabrics disclosed herein.

In the present invention, the second performance-enhancing property can be, but is not limited to, water repellency, oil repellency, stain resistance, soil release behavior, hydrophobicity, antimicrobial behavior, flame retardancy, thermal regulation, UV resistance, and combinations of two or more thereof.

### DETAILED DESCRIPTION

Methods and finishes for modifying fabrics, as well as the resulting modified fabrics are provided. Using the methods and finishes described here, a variety of fabrics can be modified to impart durable antistatic behavior and durable additional selected, or “second” performance-enhancing properties to the fabric. This invention is particularly useful in providing durable antistatic property together with a durable second performance-enhancing property to synthetic fabrics.

As used herein, “a” and “an” mean one or more, unless otherwise indicated.

“Fabrics” include natural, synthetic or man-made fibers or combinations or blends thereof, including finished goods, yarns, cloth, and may be woven or non-woven, knitted, tufted, stitch-bonded, or the like. Fabrics also include leathers, non-wovens, plastics, films, and the like. Included in the fabrics may be non-fibrous components such as particulate fillers, binders and sizes. Fibers or fabrics can comprise fibers in the form of continuous or discontinuous monofilaments, multifilaments, staple fibers, and yarns containing such filaments and/or fibers, which can be of any desired composition. Examples of natural fibers and fabrics include cotton, wool, silk, jute, and linen. Examples of man-made fibers and fabrics include regenerated cellulose, rayon, cellulose acetate, and regenerated proteins. Examples of synthetic fibers include polyesters (e.g., polyethyleneterephthalate and polypropyleneterephthalate), polyamides (e.g., nylon), acrylics, olefins, aramids, azlons, modacrylics, novoloids, nytrils, aramids, spandex, vinyl polymers and copolymers, vinal, vinyon, vinylon, Nomex® polymer (DuPont) and Kevlar® polymer (DuPont).

“Second performance-enhancing” properties or characteristics of fibers or fabrics include but are not limited to water- and/or oil-repellence, water- and/or oil-resistance, hydrophobicity, hydrophilicity, stain resistance, soil release behavior, moisture wicking, antimicrobial, flame retardancy, thermal regulation, ultraviolet (UV) resistance, and any combinations thereof.

By “durable antistatic properties” is meant herein that synthetic substrates, such as polyester and nylon, have similar or better antistatic properties than 100% cotton textiles, which properties remain with the treated substrate for at least about 10 home launderings, or for at least about 25 home launderings, or for at least about 30 home launderings, or for at least about 40 home launderings, or for at least about 50 home launderings.

“Durable second performance-enhancing properties” refers herein to properties or characteristics of a fabric that persist after cleaning, e.g., after at least about 10 home launderings of the fabric, or after at least about 25 home launderings, or after at least about 30 home launderings, or after at least about 40 home launderings, or after at least about 50 home launderings.

Although the antistatic or the second performance-enhancing properties may change from an initial level after cleaning (e.g., home laundering), they persist; that is, they remain above a minimum acceptable level after a specified number of home launderings, industrial launderings, dry cleanings, or any other method of cleaning, such as steam cleaning of carpets.

In some aspects of the invention, the treatment is permanent; that is, the antistatic and/or the second performance-enhancing property is present for the life of the treated fabric.

According to one aspect of the present invention, a fabric is exposed to a solution that contains a cationic polymer or oligomer, or a cationic coupling agent. Without being bound by theory, it is believed that the antistatic properties of the resulting treated fabric are caused by the hygroscopic nature of the applied cationic substrate, which helps to form a continuous water layer on the textile surface to dissipate static electric charges. In one aspect of the present invention, to make cationic polymers wash-fast and have satisfactory antistatic performance, the fabric is modified to make it bear negative charges prior to or subsequently with the application of cationic polymers to form polyelectrolyte complexes. Following treatment with the antistatic formulation, the fabric is treated with a composition that imparts a second performance-enhancing property to the fabric. Alternatively, the second performance-enhancing composition can be applied to the fabric first, followed by the antistatic formulation treatment. The resulting treated fabric of the invention comprises an antistatic layer disposed on at least a portion of its surface and a layer having a second performance-enhancing property disposed on at least a portion of its surface. By “disposed on at least a portion of its surface” means herein that the layer in question covers from at least about 10% of the surface of the fabric to 100% of the surface of the fabric. In one aspect, the layer covers at least about 10% of the surface of the fabric. In one aspect, the layer covers at least about 20% of the surface of the fabric. In one aspect, the layer covers at least about 30% of the surface of the fabric. In one aspect, the layer covers at least about 40% of the surface of the fabric. In one aspect, the layer covers at least about 50% of the surface of the fabric.

Thus, in one embodiment of the invention, referred to herein as the “three-step process”, a first durable coating that includes a polyelectrolyte to provide antistatic behavior and a second durable coating that includes a composition that imparts a second performance-enhancing property are applied to a surface of a fabric using three primary steps. In the first step, a surface of the fabric is modified to have an anionic, or negative, charge. One means of charging the fabric is by treating the surface with a surface-modifying anionic polymer. The anionic polymer can be applied by any appropriate method, such as padding, dipping, and the like. The anionic polymer is adsorbed onto the surface of the fabric and may be attached to the fabric through non-covalent interactions, such as hydrogen bonding or van der Waals interactions. Optionally, the anionic polymer can be applied under conditions that allow covalent bond formation between the polymer and the fabric, e.g., by the use of reactive groups on either or both the polymer and the fabric surface, or by the use of a curing step. Alternatively, a surface of the fabric can be modified to bear anionic charges by introducing charged groups such as carboxylate, sulfonate or phosphate onto the fabric surface, or by plasma-treating the fabric. Examples of fabric surface modification to form a negatively charged fabric include but are not limited to caustic denier reduction (alkaline hydrolysis), aminolysis, and other functional modification. In a second step of the three-step process, the now negatively-charged fabric surface is treated with a cationic polymer. The cationic polymer may conveniently be applied by padding or by exhausting (via dyeing machines, e.g.) onto the anionic polymer-treated substrate. The cationic polymer adsorbs onto and interacts with the modified surface of the fabric at least in part through electrostatic interactions. Alternatively, the first and second steps may be reversed, such that a cationic polymer is applied onto the fabric substrate first by padding or by exhausting, followed by application of an anionic polymer. In the third step of the three-step process, the surface-modified fabric is then treated with a composition that imparts a second performance-enhancing property to the fabric.

In other embodiments, the fabric is treated in two steps (the “two-step process”). A bath is provided containing a polyelectrolyte complex comprising both an anionic polymer and a cationic polymer. This polyelectrolyte complex is stable and may separate from the solution but generally does not precipitate out of solution. The polyelectrolyte complex is applied to the surface of the fabric to form a surface-modified fabric. The polyelectrolyte complex is adsorbed onto the surface of the fabric and can be attached to the fabric via non-covalent interactions such as hydrogen bonding or van der Waals forces. Alternatively, the complex can be applied to the surface of the fabric under conditions in which the complex can be covalently bonded to the fabric, e.g., by providing reactive groups on either or both the fabric surface and the polyelectrolyte complex or by use of a curing process. In the second step of the two-step process, the surface-modified fabric is then treated with a composition that imparts a second performance-enhancing property to the fabric.

In another embodiment of the invention, fabric is treated with a cationic coupling agent and a composition that imparts a second performance-enhancing property to the fabric, in either a one-step or a two-step process. In the two-step process, the quaternary ammonium silane is applied separately to the fabric, after which the composition that imparts a second performance-enhancing property is applied to the fabric. In the one-step process, the quaternary ammonium silane is combined with the composition that imparts a second performance-enhancing property in a one-bath one-step treatment.

In another embodiment of this invention, hydrophobic fabric (such as polyester or nylon, e.g.) is first given a hydrophilic treatment to provide durable hydrophilicity. The hydrophilic treatment can be achieved by any commercial method, such as application of CoolMax™ polyester to the fabric, or by treating the fabric substrate with other durable hydrophilic chemicals as are known in the art of polyester and nylon hydrophilic surface modifications, such as for example hydrophilic polyamide treatment or polyester alkaline surface hydrolysis. A polyelectrolyte complex is then applied onto the hydrophilic surface in either two steps (mostly by exhaustion of oppositely charged polyelectrolytes) or in one step (mostly by padding of polyelectrolyte complex solutions), following the procedures described earlier hereinabove.

With both the two-step and the three-step processes, the treated fabric is finally dried and cured to durably fix the performance-enhancing finish to the fiber or fabric. Wetting agents or surfactants that can lower the fabric surface tension may optionally be used to facilitate application of an ionic polymer or a polyelectrolyte complex to the fabric.

By “durably fix” is meant that the performance-enhancing properties of the treated fabrics described herein persist after cleaning, e.g., for at least about 10 home launderings, or at least about 25 home launderings, or at least about 30 home launderings, or at least about 40 home launderings, or for at least about 50 home launderings. In some cases, the treatment can be permanent; that is, the performance-enhancing characteristics persist for the life of the treated fabric.

In some variations, the cationic polymer useful for the finishes, methods, and fabrics described herein have a positive charge density greater than 1 meq/g. Particularly useful charge densities are 4.0 meq/g or higher, 6.0 meq/g or higher, or 8.0 meq/g or higher. The cationic polymers are selected from those having a high molecular weight, e.g., from about 10,000 to 1,000,000, or from about 10,000 to about 100,000, or from about 100,000 to about 300,000, or from about 300,000 to about 500,000, or from about 500,000 to about 700,000, or from about 700,000 to about 1,000,000. Monomers of these cationic polymers include, but not limited to: 2-aminoethyl methacrylate hydrochloride, N-(3-aminopropyl)methacrylamide hydrochloride, 4,4′-diamino-3,3′-dinitrodiphenyl ether, 3,3′-diaminodiphenyl sulfone, 2-(tert-butylamino)ethyl methacrylate, diallylamine, 2-(iso-propylamino)ethylstyrene, ethylene imine, 2-(N,N-diethylamino)ethyl methacrylate, 2-(diethylamino)ethylstyrene, 2-(N,N-dimethylamino)ethyl acrylate, N-[2-(N,N-dimethylamino)ethyl]methyacrylamide, 2-(N,N-dimethylamino)ethyl methacrylate, N-[3-(N,N-dimethylamino)propyl]acrylamide, N-[3-(N,N-dimethylamino)propyl]-methacrylamide, 2-vinylpyridine, 4-vinylpyridine, 2-acryloxyethytrimethylammonium chloride, diallyldimethylammonium chloride, 2-methacryloxyethyltrimethylammonium chloride. The cationic polymers may be branched, e.g., from about 0.001% to about 10% branched. In particular, examples of cationic polymers that may be used for the finishes described herein include polyquaternium-16, with molecular weight of approximately 40,000 and a charge density of 6.1 meq/g; polyquaternium-1; polyquaternium-4; polyquaternium-5; polyquaternium-7; polyquatemium-10; polyquaternium-11; polyquaternium-22; and poly(diallyldimethylammonium chloride) (PDADMAC), with molecular weight of 100,000-500,000 and charge density of 6.2 meq/g.

In some variations, anionic polymers useful for the finishes, methods, and fabrics described herein have a high negative charge density (>1 meq/g). In some variations, the anionic polymer will have a negative charge density of 4.0 meq/g or higher, or 6.0 meq/g or higher, or 8.0 meq/g or higher, or 10.0 meq/g or higher. When used in the three-step process described above, the anionic polymer will preferably have a high molecular weight, e.g., from 100,000 to 1,000,000 Dalton, or from about 100,000 to about 300,000, or from about 300,000 to about 500,000, or from about 500,000 to about 800,000 or from about 800,000 to about 1,000,000. When used in the two-step process described above, the anionic polymer will have a lower molecular weight, e.g., from 1,000 to 100,000 Dalton, or from about 1,000 to about 3,000, or from about 3,000 to about 5,000, or from about 5,000 to about 10,000, or from about 10,000 to about 20,000, or from about 20,000 to about 40,000, or from about 40,000 to about 60,000, or from about 60,000 to about 80,000, or from about 80,000 to about 100,000. Without being bound by theory, it is believed that the lower molecular weight anionic polymer allows some suspendability in aqueous solution which stabilizes the polyelectrolyte complex of the anionic and cationic polymers.

In some variations, anionic polymers that may be used for the finishes, methods, and fabrics described herein include those that contain carboxyl, carboxylate, or carboxyl precursor groups, which are referred to herein and the appended claims as “carboxyl-containing polymers” or “polycarboxylates”. The carboxyl-containing polymers can be obtained through polymerization or copolymerization of one or more monomers that contain a carboxyl group, a carboxylate, or a group that can become a carboxyl or carboxylate group through a chemical reaction (a carboxyl precursor group). Non-limiting examples of such monomers include: acrylic acid, methacrylic acid, aspartic acid, glutarnic acid, B-carboxyethyl acrylate, maleic acid, monoesters of maleic acid [ROC(O)CH═CHC(O)OH, where R represents an alkyl group, or a perfluoroalklyl group], maleic anhydride, fumaric acid, monoesters of fumaric acid [ROC(O)CH═CHC(O)OH, where R represents an alkyl group or perfluoroalkyl group], acrylic anhydride, crotonic acid, cinnamic acid, itaconic acid, itaconic anhydride, monoesters of itaconic acid [ROC(O)CH₂(═CH₂)C(O)OH, where R represents an alkyl group or a perfluoroalklyl group], saccharides with carboxyl (e.g., alginic acid), carboxylate, or carboxyl precursor groups, and macromonomers that contain carboxyl, carboxylate, or carboxyl precursor groups. Carboxyl precursors include, but are not limited to, acid chlorides, N-hydroxysuccinimidyl esters, amides, esters, nitriles, and anhydrides. Examples of monomers with carboxyl precursor groups include (meth)acrylate chloride, (meth)acrylamide, N-hydroxysuccinimide (meth)acrylate, (meth)acrylonitrile, asparigine, and glutamine. Herein the designation “(meth)acryl” indicates both the acryl- and methacryl-versions of the monomer. Carboxylate cations can include aluminum, barium, chromium, copper, iron, lead, nickel, silver, strontium, zinc, zirconium, and phosphonium (R₄P⁺, where R represents an alkyl or perfluoroalkyl group). Other useful cations include hydrogen, lithium, sodium, potassium, rubidium, ammonium, calcium, and magnesium. The anionic polymers may be linear or branched. In some aspects of the invention, the anionic polymers are branched. In some aspects, the anionic polymers have between about 0.001% and about 10% branching, inclusive. In some aspects, the anionic monomers are selected from acrylic acid, methacrylic acid and β-carboxyethyl acrylate, and in some aspects the polycarboxylate is poly(acrylic acid).

If polymers that contain carboxyl precursor groups are used as the carboxyl-containing anionic polymer, the precursors must be hydrolyzed to form carboxyl groups either during or after application of the functionalized polyelectrolyte to the fabric. Conditions for hydrolysis depend on the nature of the precursors. In some situations, the hydrolysis can occur under similar pH and temperature conditions to those at which the fabric is being treated, which can facilitate formation of the carboxyl groups as the functionalized ionic polymer is being applied to the fabric. Examples of precursor groups include acid chlorides and anhydrides. Other precursor groups may require acidic or basic aqueous conditions and elevated temperatures for hydrolysis; such groups include esters and amides.

Other anionic polymers bearing high negative charge density, such as sulfonate- or phosphate-containing polymers, can be applied to the fabric by any suitable technique, e.g., by padding or exhaustion. Examples include poly(styrene sulfonate), molecular weight about 1 million, charge density of 4.9 meq/g, sulfonated polyester fiber, poly(vinyl sulfonate), taurine, and aspartic acid. Surface modification using hydrolysis (alkaline or amino acids) is typically done in dyeing machines over a temperature range between 20° C. and 120° C., or between 40° C. and 100° C., or between 60° C. and 90° C.

Suitable cationic coupling agents for use in the invention include but are not limited to amino silanes and quaternary ammonium silanes. Quaternary ammonium silane coupling agents have been previously used on textiles for antimicrobial finishing. Known commercial products include Dow Coming 5700 and Mason Chemicals Maquat® QSX. These silanes can hydrolyze into reactive silanols during the finishing process, which can further crosslink with itself and other hydrogen-containing reactive groups to form durable coatings. It has now been discovered that, according to the present invention, when silanes are applied with sufficient concentration (normally from about 0.5% to about 10%, or from about 1% to about 5% of active quaternary ammonium silane), which “sufficient concentration” is greater than that concentration which is commonly used for antimicrobial finishing, the treated fabric will exhibit good antistatic property that is compatible with water and oil repellent finishing.

The compositions that impart a second performance-enhancing property to a synthetic fabric according to the present invention are known to those skilled in the art, such as, e.g., those discussed by C. Tomasino in Chemistry & Technology of Fabric Preparation & Finishing, Ch. 9 (North Carolina State University, 1992), the disclosure of which is incorporated herein by reference. In one aspect, the compositions can be selected from water repellent or oil-and-water repellent finishes. These include waxes, fiber-reactive hydrocarbon hydrophobes, silicones and fluorochemical compounds. In one aspect, the compositions can be selected from soil-release finishes. These include acrylics, dual-action fluorochemical compounds and hydrophilic soil-release finishes.

The polymers, cationic coupling agents and other performance-enhancing treatment compositions can be applied to fabrics by any suitable technique, such as by exhaustion, e.g., in a dyeing machine, in continuous or batch mode, or by padding, by spray coating, or by adding in during the laundry process. Formulations of the various treatment compositions can be adjusted as appropriate for the application method being used.

In applying the polymers, cationic coupling agents and other performance-enhancing compositions to a fabric, the process temperature can vary widely, depending on the reactivity of the reactants. However, the temperature should not be so high as to decompose the reactants or so low as to cause inhibition of the reaction or freezing of the solvent. Unless specified to the contrary, the fabric is exposed to the polymers at atmospheric pressure over a temperature range between 5° C. and 110° C., more preferably between 15° C. and 60° C., and most preferably at room temperature, approximately 20° C. The pH at which the polymers are applied may be between pH 0 to pH 7, preferably between pH 1 to pH 5, and more preferably between pH 2 to pH 4.5. The time required for the processes herein will depend to a large extent on the temperature being used and the relative reactivities of the starting materials. Unless otherwise specified, the process times and conditions are intended to be approximate. Curing conditions may range from 5° C. to 250° C., preferably between 150° C. and 200° C.

The “fibrous substrates” or “fabrics” of the present invention are intended to include fibers, fabrics and textiles, and may be sheet-like structures (woven, knitted, tufted, stitch-bonded, or non-woven) comprised of fibers or structural elements. Included with the fibers can be non-fibrous elements, such as particulate fillers, binders, and sizes. The fibrous substrates or fabrics include fibers, woven and non-woven fabrics derived from natural or synthetic fibers or blends of such fibers. They can comprise fibers in the form of continuous or discontinuous monofilaments, multifilments, staple fibers, and yarns containing such filaments and/or fibers, which fibers can be of any desired composition. Examples of natural fibers include cotton, wool, silk, jute, and linen. Examples of man-made fibers include regenerated cellulose rayon, cellulose acetate, and regenerated proteins. Examples of synthetic fibers include, but are not limited to, polyesters (including polyethyleneterephthalate and polypropyleneterephthalate), polyamides (including nylon), acrylics, olefins, aramids, azlons, modacrylics, novoloids, nytrils, aramids, spandex, vinyl polymers and copolymers, vinal, vinyon, vinylon, Nomex® (DuPont) and Kevlar® (DuPont). Mixtures of natural fibers and synthetic fibers may also be used and are encompassed within “synthetic” fibrous substrates and “synthetic” fabrics.

In one aspect, the present invention is directed to synthetic fibers, yarns, fabrics, finished goods, or other textiles that are treated with a finish for imparting antistatic property and a second performance-enhancing property to the synthetic fabric. These treated textiles or webs will display antistatic characteristics usually associated with hydrophilic textiles (e.g. cotton) while retaining the traditional advantages of synthetic textiles, such as strength and durability. They will also exhibit a second performance-enhancing property such as, but not limited to, soil-release characteristics, repellency to oil and/or water or hydrophilicity. The antistatic characteristics and second performance-enhancing characteristics of the treated fabrics of the invention are durable.

The treated fabrics of the invention can be used in a variety of ways including, but not limited to the following: clothing, upholstery and other interior furnishings, hospital and other medical uses, and industrial uses. The Wellington Sears Handbook of Industrial Textiles (Ed. S. Adanur, Technomic Publishing Co., Lancaster, Pa. 1995, p. 8-11) lists a number of potential uses.

### EXAMPLES

The following non-limiting examples are provided to allow further understanding of the compositions and methods for treating fabrics described herein

General Information:

Standard home launderings are done based on AATCC method 124-2001, last modified in 2001, but substituting 28 grams of granular Tide® detergent (Proctor & Gamble) for the 66 grams of 1993 AATCC standard reference detergent. To conduct a home laundering, a square piece of fabric (approximately 8″8″) was placed in a standard home washing machine. The samples were washed with warm water on the “normal” wash and spin cycles. The samples were tumble dried as stated in the standard AATC method 124-2001.

One performance target is to make synthetic fabrics, such as polyester and nylon fabrics, have the same or better antistatic properties (surface resistivity, cling time, and static decay) as 100% cotton fabrics. Antistatic performance can be measured by industrial standard AATCC 76-2000 or ASTM D257-99, set forth in Table A below (from Chemical Finishing of Textiles, Wolfgang D. Schindler and Peter J. Hauser, 2004, Woodhead Publishing, Limited). A surface resistivity of greater than 5×10¹¹ ohm/square is considered inadequate although surface resistivities that differ from these values may be consumer relevant and desirable.

TABLE A
Industrial anti-static performance classification
(65% relative humidity, 20° C.)

| Surface resistivity (ohm/square) | Anti-static Grade |
|---|---|
| 1.00 × 10⁷-1.00 × 10⁹ | Very Good |
| 1.00 × 10⁹-1.11 × 10¹⁰ | Good |
| 1.00 × 10¹⁰-1.00 × 10¹¹ | Satisfactory |
| 1.00 × 10¹¹-5.00 × 10¹¹ | Sufficient |
| >5.00 × 10¹¹ | Inadequate |

Another performance target is to make synthetic fabrics water-repellent or water- and oi-repellent. Water spray and oil repellency can be measured by AATCC methods 22-2001 and 118-1997.

Another performance target is to provide synthetic fabrics with soil release properties. Soil release can be measured by AATCC 130-2000.

Another performance target for synthetic fabrics to be more hydrophilic and water-absorbent. Water absorbency can be measured by AATCC 79-2000.

### Example 1

In a first step, swatches of polyester fabric (plain woven, 6 oz/yd²) were treated with poly(acrylic acid) (PAA) as follows: Each fabric sample was dipped into an aqueous solution containing 0.2 wt. % PAA (average molecular weight 1,000,000, pH 3.3-3.9) and 0.1 wt. % WetAid™ wetting agent, and was padded to a wet pick-up of approximately 100%. The samples were dried at 250° F. for 5 minutes, then cured at 320° F. for 30 seconds, after which they were washed and dried.

In a second step, an aqueous solution of 1% to 10% (by weight, based on solid content) cationic polymer polyquatemium-16 (molecular weight about 40,000; 40% solid content) was applied to the PAA-treated fabric. Polyquatemium-16 solution was padded with a 60% to 100% wet pick-up onto a PAA-treated polyester swatch. The sample was then dried and conditioned at 60% relative humidity and 70° F. for at least 4 hours before testing. The surface resistivity of the polyester swatch measured at 60% relative humidity (RH), 70° F. was rated “sufficient” after 5 home launderings.

### Example 2

PAA-treated polyester fabric from the first step of Example 1 was dipped into a 3-5 wt. % aqueous solution of PDADMAC (molecular weight 400,000-500,000; 20% solid content) and padded to 90-100% wet pick-up. The fabric was then dried at 300° F. for 30 seconds. Surface resistivity as a function of number of home launderings is reported in Table B below.

### Example 3

PAA-treated polyester fabric from the first step of Example 1 was dipped into a 2-3 wt. % aqueous solution of Polyquatemium-16 (molecular weight about 40,000; 40% solid content) and padded to 90-100% wet pick-up. The fabric was then dried at 300° F. for 30 seconds. Surface resistivity as a function of number of home launderings is reported in Table B below.

### Example 4

A 3-5% (all weight on goods for exhaustions) aqueous solution of PDADMAC (molecular weight 400,000-500,000; 20% solid content) (liquor ratio 10:1) was exhausted onto anionically-modified PAA-treated polyester fabric from the first step of Example 1 in a dyeing machine for 15-30 minutes at 40°-60° C. Samples were then rinsed, dried and conditioned at 60% relative humidity and 70° F. for at least 4 hours before testing. Surface resistivity is reported as a function of number of home launderings is provided in Table B below.

### Example 5

A 2-3% (weight on goods) aqueous solution of polyquatemium-16 (molecular weight 40,000; 40% solid content) (liquor ratio 10:1) was exhausted onto anionically-modified PAA-treated polyester fabric from the first step of Example 1 in a dyeing machine for 15-30 minutes at 40°-60° C. Samples were then rinsed, dried and conditioned at 60% relative humidity and 70° F. before testing. Surface resistivity as a function of number of home launderings is provided in Table B below.

### Example 6

Polyester fabric samples (plain woven, 6 oz/yd²) were treated in a one-step process by padding, as follows: 6% (by weight) cationic polymer PDADMAC (molecular weight 400,000-500,000; 20% solid content), was dissolved in water, after which 4% (by weight) NaCl and 1% (by weight) anionic polymer (PAA, molecular weight approximately 1,000-10,000; 50% solid content) were added, with stirring to form a polyelectrolyte complex. Additionally, 0.2% (by weight) cetyltrimethylammonium chloride (CTAC; 20% solid content) was added to the solution as a surfactant. The fabric was dipped in the prepared solution of polyelectrolyte complex and padded to 100% wet pick-up. It was then dried and cured at 380° F. for 30 seconds. Surface resistivity as a function of number of home launderings is provided in Table B below.

### Example 7

Polyester fabric samples (plain woven, 6 oz/yd²) were treated in a one-step application by exhaustion, as follows: 0.5% to 1% (by weight) of cationic polymer, PDADMAC (molecular weight 400,000-500,000; 20% solid content) was dissolved in water (5:1 to 20:1 liquor ratio), after which 0.2% to 6% (by weight) anionic polymer (PAA, having molecular weight of approximately 1,000-100,000; 50% solid content) were added, with stirring. The prepared solution of polyelectrolyte complex was exhausted onto fabric at 30° C. to 100° C. for 10 minutes to 30 minutes. Samples were dried at 250° F. for 5 minutes. Surface resistivity as a function of number of home launderings is provided in Table B below.

### Example 8

Polyester fabric samples (plain woven, 6 oz/yd²) were treated in a one-step application by alternatively depositing cationic polymer and anionic polymer layers on substrates in a dyeing machine. Liquor ratios are from 5:1 to 20:1 and all weights were based on goods. Exhaustion temperature range is from 30° C. to 100° C. A total of 0.5% to 10% (by weight) of polyquaternium-16 (molecular weight about 40,000; 40% solid content) was dissolved in water. The same procedure was applied to make an aqueous solution of 0.1% to 6% (by weight) anionic polymer (PAA, molecular weight less than 1,000,000; 50% solid content). The solution of the cationic polymer then was added into the dyeing machine alternatively with the solution of the anionic polymer to be exhausted onto the fabric in multiple portions. The total process took about 30 to 60 minutes. After the exhaustion, all samples were rinsed, dried at 250° F. for 5 minutes, and conditioned at 60% relative humidity, 70° F., before testing. Surface resistivity as a function of number of home launderings is provided in Table B below.

Surface Resistivity Data

Surface resistivities (ohm/sq) of 100% polyester (woven, 6 oz/yd²) samples treated as described in Examples 2 to 8, along with 100% cotton and untreated polyester samples, are listed in Table B, as a function of number of home launderings (HL).

TABLE B
Surface resistivity of treated and untreated samples (60% relative humidity, 20° C.), measured in ohm/sq.

| Fabric Type | 0HL | 1HL | 5HL | 10HL | 20HL | 30HL |
|---|---|---|---|---|---|---|
| 100% woven cotton, 4 oz/yd² | 2.22 × 10¹⁰ | 6.37 × 10¹⁰ | 1.73 × 10¹¹ | 1.49 × 10¹¹ | 2.18 × 10¹¹ | 2.20 × 10¹¹ |
| 100% woven cotton, 8 oz/yd² | 1.10 × 10¹⁰ | 3.22 × 10¹⁰ | 1.14 × 10¹¹ | 7.17 × 10¹⁰ | 1.27 × 10¹¹ | 1.02 × 10¹¹ |
| 100% untreated woven | >2.00 × 10¹² | >2.00 × 10¹² | >2.00 × 10¹² | >2.00 × 10¹² | >2.00 × 10¹² | >2.00 × 10¹² |
| polyester 6 oz/yd² | | | | | | |
| Example 2 | 4.87 × 10⁷ | 3.82 × 10¹⁰ | 2.32 × 10¹⁰ | 2.78 × 10¹⁰ | 1.53 × 10¹⁰ | 2.21 × 10¹⁰ |
| Example 3 | 1.29 × 10⁸ | 7.83 × 10¹⁰ | 2.53 × 10¹⁰ | 3.69 × 10¹⁰ | 6.45 × 10¹⁰ | 4.47 × 10¹⁰ |
| Example 4 | 1.26 × 10¹⁰ | 3.15 × 10¹⁰ | 1.71 × 10¹⁰ | 1.87 × 10¹⁰ | 2.43 × 10¹⁰ | 1.46 × 10¹⁰ |
| Example 5 | 4.32 × 10¹⁰ | 6.19 × 10¹⁰ | 4.35 × 10¹⁰ | 4.73 × 10¹⁰ | 6.93 × 10¹⁰ | 7.53 × 10¹⁰ |
| Example 6 | 2.87 × 10⁷ | 7.32 × 10¹⁰ | 2.15 × 10¹⁰ | 7.44 × 10¹⁰ | 1.61 × 10¹⁰ | 5.51 × 10¹⁰ |
| Example 7 | 1.92 × 10¹⁰ | 1.46 × 10¹⁰ | — | 5.20 × 10⁹ | 3.03 × 10⁹ | 7.04 × 19⁹ |
| Example 8 | 3.00 × 10¹⁰ | 6.92 × 10⁹ | 2.81 × 10⁹ | 3.02 × 10⁹ | 1.08 × 10¹⁰ | 1.07 × 10¹⁰ |

### Example 9

Antistatic treatment (all weights on goods): 3% polyquaternium-6 (molecular weight about 40,000; 20% solid content), 1% anionic polymer poly(acrylic acid) (PAA) (molecular weight about 1,000-10,000; 50% solid content), and 3% cationic softener Cognis® S150 (Cognis product) were exhausted sequentially onto polyester fleece fabric (11.75 oz/yd²) or polyester woven fabric (6 oz/yd²) in a jet dyeing machine at the temperature range from 20° C. to 40° C. All fabrics then were dried in a tenter frame.

Water/oil repellent treatment (all weights on bath): In a second step, a finishing bath containing 0.1-0.2% non-rewetting agent, 6% acrylic-type fluoropolymer with perfluorinated 8-carbon branch chain (NT-X168; Nano-Tex), 1% melamine-based extender (NT-E711; Nano-Tex), and 1% non-durable antistatic phosphate Zerostat® FC New (Ciba) was prepared. The antistatic-treated fabrics were dipped through the finishing bath solution and padded with a 50%-100% wet pickup, then dried and cured at 360° F. for 1 minute.

Surface resistivity and water and oil repellency were measured, and are presented in Table C

TABLE C
Surface resistivity (SR), water and oil repellency
of treated polyester fleece and woven fabrics

| Home laundry | | Polyester Woven | Polyester Fleece |
|---|---|---|---|
| Initial | SR | 9.49 × 10¹⁰ | 6.83 × 10⁹ |
| | Oil | 6.5 | 6 |
| | Spray | 85 | 85 |
| 5 | SR | | 2.80 × 10¹⁰ |
| | Oil | | 6 |
| | Spray | | 80 |
| 10 | SR | 2.45 × 10¹⁰ | 5.06 × 10⁹ |
| | Oil | 5.5 | 6 |
| | Spray | 85 | 75/80 |
| 20 | SR | 3.56 × 10¹⁰ | 5.20 × 10⁹ |
| | Oil | 5.5 | 6 |
| | Spray | 80/85 | 75/80 |
| 30 | SR | 3.63 × 10¹⁰ | 2.14 × 10¹⁰ |
| | Oil | 4.5 | 6 |
| | Spray | 80/85 | 90 |

### Example 10

In a first step, polyester woven fabric (6 oz/yd²) was treated according to the antistatic treatment procedure in Example 9.

Water/oil repellent and soil release treatment (all weights on bath): In a second step, a finishing bath containing 0.1-0.2% non-rewetting agent, 4% fluoropolymer NT-604B (Nano-Tex repellent and soil release fluorochemical), and 0.6% blocked isocyanate crosslinker Repearl® MF (Mistsubishi) was prepared. Treated fabric from step 1 was dipped through the solution and padded with a 50%-100% wet pickup, then dried and cured at 330° F. for 1 minute.

Surface resistivity, water and oil repellency and soil release were measured, and are presented in Table D.

TABLE D
Surface resistivity (SR), water and oil repellency,
soil release of treated polyester woven fabric

| Home laundry | Performance | Polyester Woven |
|---|---|---|
| Initial | SR | 9.11 × 10¹⁰ |
| | Oil | 6.0 |
| | Spray | 70 |
| | Soil Release | 3.5 |
| 30 | SR | 4.24 × 10¹¹ |
| | Oil | 1.0 |
| | Spray | 50 |
| | Soil Release | 4.5 |

### Example 11

Antistatic treatment (all percentages based on the weight of the bath): 5% Quaternary ammonium silanes (Maquat® QSX-18SE/75BG), bath pH=5-6, was padded onto polyester woven fabric (6 oz/yd²) with a 50% -100% wet pickup, then dried and cured at 350° F. for 1 minute in a tenter frame.

In a second step, the treated fabric was treated following the water/oil repellent treatment procedure of Example 9.

Surface resistivity and water and oil repellency were measured, and are presented in Table E.

### Example 12

Antistatic and water/oil repellent one-bath one-step treatment (all percentages based on the weight of the bath): A finishing bath containing 0.1-0.2% non-rewetting agent, 5% quaternary ammonium silanes (Maquat® QSX-18SE/75BG), 6% acrylic-type fluoropolymer with perfluorinated 8-carbon branch chain (NT-X168; Nano-Tex), and 1% melamine-based extender (NT-E711; Nano-Tex) was prepared. Bath pH was adjusted to 4-5 with citric acid. A plain woven polyester fabric (6 oz/yd²) was padded through the solution with a 50% -100% wet pickup, then dried and cured at 350° F. for 1 minute in a tenter frame. Surface resistivity and water and oil repellency were measured, and are presented in Table E.

TABLE E
Surface resistivity (SR), water and oil repellency
of treated polyester fleece and woven fabrics

| Home laundry | | Two-step, | One-step, |
|---|---|---|---|
| cycles | | Example 11 | Example 12 |
| Initial | SR | 2.04 × 10⁸ | 2.79 × 10⁸ |
| | Oil | 7.5 | 6.5 |
| | Spray | 100 | 100 |
| 5 | SR | 1.74 × 10⁹ | 3.18 × 10⁹ |
| | Oil | 6.5 | 6.5 |
| | Spray | 80 | 80 |
| 10 | SR | 2.59 × 10⁹ | 8.05 × 10⁹ |
| | Oil | 6.5 | 6.5 |
| | Spray | 75/80 | 80/85 |
| 20 | SR | 5.48 × 10¹⁰ | 7.64 × 10¹⁰ |
| | Oil | 6.0 | 6.5 |
| | Spray | 80 | 100 |
| 30 | SR | 4.01 × 10¹¹ | 1.43 × 10¹¹ |
| | Oil | 6.0 | 7.0 |
| | Spray | 80 | 100 |

### Example 13

Hydrophilic treatment (all percentages based on the weight of the goods): 6% polyocyethylene terephthalate hydrophilic polymer, bath pH=5-6, was exhausted onto poylester woven fabric (5.5 oz/yd²) at 130° C. for 30 minutes with a 10:1 liquor ratio. The treated fabric was rinsed and dried.

Antistatic treatment: The hydrophilic-treated fabric was then treated following the procedure in Example 9, but replacing softener Cognis S150 with a hydrophilic softener, e.g. Ceraperm® MN (Clariant).

Surface resistivity and water absorbency were measured, and are presented in Table F.

TABLE F
Surface resistivity (SR) and water absorbency
(seconds) of treated polyester woven fabric

| Home laundry | Performance | Polyester Woven |
|---|---|---|
| Initial | SR | 2.34 × 10¹⁰ |
| | Absorbency | 18 |
| 20 plus extra | SR | 6.60 × 10⁹ |
| rinsing cycle | Absorbency | 3 |
| 30 plus extra | SR | 1.14 × 10¹⁰ |
| rinsing cycle | Absorbency | 2 |

Although the foregoing compositions, methods and fabrics, have been described in some detail by way of illustration and example for purposes of clarity of understanding, it is apparent to those skilled in the art that certain minor changes and modifications will be practiced. Therefore, the description and examples should not be construed as limiting the scope of the invention.

What is claimed is:

1. A finish for imparting antistatic property and a second performance-enhancing property to a fabric, the finish comprising i) one layer comprising a cationic and anionic polymer complex or a cationic coupling agent, and ii) another layer comprising a composition capable of imparting the second performance-enhancing property to the fabric; and wherein the antistatic property and the second performance-enhancing property are durable.

2. The finish of claim 1, wherein the anionic polymer comprises carboxyl, carboxylate, carboxyl precursor groups, sulfonate, sulfate, or phosphate groups.

3. The finish of claim 1, wherein the cationic polymer comprises a monomer selected from the group consisting of: 2-aminoethyl methacrylate hydrochloride, N-(3-aminopropyl)methacrylarnide hydrochloride, 4,4′-diamino-3,3′-dinitrodiphenyl ether, 3,3′-diaminophenyl sulfone, 2-(tert-butylamino)ethyl methacrylate, diallylamine, 2-(iso-propylamino)ethylstyrene, ethylene imine, 2-(N,N-diethylamino)ethyl methacrylate, 2-(diethylamino)ethylstyrene, 2-(N,N-dimethylamino)ethyl acrylate, N-[2-(N,N-dimethylamino)ethyl]methyacrylamide, 2-(N,N-dimethylamino)ethyl methacrylate, N-[3-(N,N-dimethylamino)propyl]acrylamide, N-[3-(N,N-dimethylamino)propyl]methacrylamide, 2-vinylpyridine, 4-vinylpyridine, 2-acryloxyethytrimethylammonium chloride, diallydimethylammonium chloride, and 2-methacryloxyethyltrimethylammonium chloride.

4. The finish of claim 1, wherein the cationic coupling agent comprises an amino silane or a quaternary ammonium silane.

5. The finish of claim 1, wherein the second performance-enhancing property is selected from the group consisting of water-repellence, oil-repellence, stain-resistance, soil release behavior, hydrophobicity, hydrophilicity, antimicrobial behavior, flame retardancy, thermal regulation and UV resistance.

6. The finish of claim 1, wherein the composition capable of imparting the second performance-enhancing property is selected from the group consisting of a silicone water repellent, a hydrocarbon wax water repellent, a fluorochemical-containing water repellent, and a combination water repellent and soil release fluorochemical-containing composition.

7. The finish of claim 1, wherein the cationic polymer comprises poly(diallyldimethylammonium chloride) or a polyquatemium polymer; the anionic polymer comprises polyacrylic acid, polycarboxylic acid, polycarboxylate, polysulfonic acid or polysulfonate; and the composition capable of providing a second performance-enhancing property comprises a silicon water repellent, a hydrocarbon wax water repellent, a fluorochemical-containing water repellent, or a combination water repellent and soil release fluorochemical-containing composition.

8. The finish of claim 1, wherein the cationic polymer comprises poly(diallyldimethylammonium chloride) or a polyquatemium polymer; the anionic polymer comprises polyacrylic acid, polycarboxylic acid, polycarboxylate, polysulfonic acid or polysulfonate; and the composition capable of providing a second performance-enhancing property comprises a hydrophilic polyester.

9. A fabric exhibiting antistatic property and a second performance-enhancing property, the fabric comprising a finish disposed thereon, wherein the finish comprises i) one layer disposed on at least a portion of the fabric, the layer comprising a cationic and anionic polymer complex or a cationic coupling agent, and ii) another layer disposed on at least a portion of the fabric, the layer comprising a composition capable of imparting the second performance-enhancing property to the fabric; and wherein the antistatic property and the second performance-enhancing property are durable.

10. The fabric of claim 9, wherein the anionic polymer comprises carboxyl, carboxylate, carboxyl precursor groups, sulfonate, sulfate, or phosphate groups.

11. The fabric of claim 9, wherein the cationic polymer comprises a monomer selected from the group consisting of: 2-aminoethyl methacrylate hydrochloride, N-(3-aminopropyl)methacrylamide hydrochloride, 4,4′-diamino-3,3′-dinitrodiphenyl ether, 3,3′-diaminophenyl sulfone, 2-(tert-butylamino)ethyl methacrylate, diallylamine, 2-(iso-propylamino)ethylstyrene, ethylene imine, 2-(N,N-diethylamino)ethyl methacrylate, 2-(diethylamino)ethylstyrene, 2-(N,N-dimethylamino)ethyl acrylate, N-[2-(N,N-dimethylamino)ethyl]methyacrylamide, 2-(N,N-dimethylamino)ethyl methacrylate, N-[3-(N,N-dimethylamino)propyl]acrylamide, N-[3-(N,N-dimethylamino)propyl]methacrylamide, 2-vinylpyridine, 4-vinylpyridine, 2-acryloxyethytrimethylammonium chloride, diallydimethylammonium chloride, and 2-methacryloxyethyltrimethylammonium chloride.

12. The fabric of claim 9, wherein the cationic coupling agent comprises an amino silane or a quaternary ammonium silane.

13. The fabric of claim 9, wherein the second performance-enhancing property is selected from the group consisting of water-repellence, oil-repellence, stain-resistance, soil release behavior, hydrophobicity, hydrophilicity, antimicrobial behavior, flame retardancy, thermal regulation and UV resistance.

14. The fabric of claim 9, wherein the composition capable of imparting the second performance-enhancing property is selected from the group consisting of a silicone water repellent, a hydrocarbon wax water repellent, a fluorochemical-containing water repellent, and a combination water repellent and soil release fluorochemical-containing composition.

15. The fabric of claim 9, wherein the cationic polymer comprises poly(diallyldimethylammonium chloride) or a polyquatemium polymer; the anionic polymer comprises polyacrylic acid, polycarboxylic acid, polycarboxylate, polysulfonic acid or polysulfonate; and the composition capable of providing a second performance-enhancing property comprises a silicon water repellent, a hydrocarbon wax water repellent, a fluorochemical-containing water repellent, or a combination water repellent and soil release fluorochemical-containing composition.

16. The fabric of claim 9, wherein the cationic polymer comprises poly(diallyldimethylammonium chloride) or a polyquatemium polymer; the anionic polymer comprises polyacrylic acid, polycarboxylic acid, polycarboxylate, polysulfonic acid or polysulfonate; and the composition capable of providing a second performance-enhancing property comprises a hydrophilic polyester.

17. The fabric of claim 9, wherein the finish comprises i) a first layer comprising a cationic and anionic polymer complex or a cationic coupling agent, and ii) a second layer comprising a composition capable of imparting the second performance-enhancing property to the fabric.

18. The fabric of claim 9, wherein the fabric is a synthetic fabric and wherein the finish comprises i) a first layer comprising a composition that imparts hydrophilicity to the fabric, and ii) a second layer comprising a cationic and anionic polymer complex or a cationic coupling agent.

19. A method of treating a fabric to impart durable antistatic property and a durable second performance-enhancing property, the method comprising:
a) applying a layer comprising a cationic and anionic polymer complex or a cationic coupling agent to the fabric;
b) applying a composition to the fabric, wherein the composition is capable of imparting the second performance-enhancing property to the fabric; and
c) drying and curing the fabric to durably fix the composition to the fabric.
